(19) United States
(12) Patent Application Publication
(10) Pub. No.: US 2018/0124365 A1
(43) Pub. Date: May 3, 2018

(54) 3D PROJECTOR FOR MOBILE PHONE

(71) Applicant: Kin Wo LEE, Hong Kong (HK)

(72) Inventor: Kin Wo LEE, Hong Kong (HK)

(21) Appl. No.: 15/432,056

(22) Filed: Feb. 14, 2017

(30) Foreign Application Priority Data
Oct. 28, 2016 (CN) 201610969281.0

(51) Int. Cl. H04N 9/31; G02B 7/18; G03B 35/00; H04N 13/04

(52) U.S. Cl. CPC H04N 9/3173; G02B 7/1805; H04W 4/008; H04N 13/04; G03B 35/00

(57) ABSTRACT

A 3D projector for mobile phone, comprising an inverted-L shaped frame, a signal receiver disposed inside the inverted-L shaped frame for receiving a mobile phone application program, a main pyramidal prism disposed directly on top of a display of the mobile phone, and an auxiliary pyramidal prism disposed directly on top of a front camera of the mobile phone. With the 3D projector for mobile phone as described, when such 3D projector is used, signal can be received through the inverted-L shaped frame, achieving upwards or downwards movement or rotation of the main pyramidal prism. Projection is achieved through the main pyramidal prism, thereby allowing viewers to watch 3D movies using mobile phones, and can also adjust 3D effects through making simple gestures according to the plot or viewer desire. This meets and satisfies the need for technology and experience of entertainment for the young people today.

### BACKGROUND OF INVENTION

The present invention relates to the field of mobile phone projectors, in particular to a 3D projector for mobile phone.

A mobile phone does not only provide phone calling and messaging functions, more and more diversity among functions of mobile phones is being developed the society today. 2D movies no longer satisfy the demands of movie viewers, viewers in particular young viewers like the excitement and reality provided by 3D movies. Reliance by the young to mobile phone functions is also becoming obvious when more tasks can be performed by mobile phones, people are already used to online gaming, online shopping, and online payment. However, feeling 3D movie effects through a mobile phone has not been developed yet.

### SUMMARY OF INVENTION

The technical problem to be solved by the present invention is: to overcome the aforementioned problem, a 3D projector for mobile phone is provided. The projector allows viewers to watch 3D movies through a mobile phone, and can also adjust 3D effects through simple gestures based on the plot or viewer desire.

The technical solution used in the present invention to solve the technical problem is: a 3D projector for mobile phone, comprising an inverted-L shaped frame, a signal receiver disposed inside the inverted-L shaped frame for receiving a mobile phone application program, a main pyramidal prism disposed directly on top of a display of the mobile phone, and an auxiliary pyramidal prism disposed directly on top of a front camera of the mobile phone. To realize the viewer performing move up, move down or rotate gestures in front of the auxiliary pyramidal prism, the gestures are projected onto the front camera through the auxiliary pyramidal prism, the front camera further sending a signal to the application program.

The inverted-L shaped frame comprises a base, a vertical extender vertically connected on top of the base, a horizontal bar horizontally connected to a top end of the vertical extender, a turntable rotationally connected to a bottom surface at an end of the horizontal bar, and a horizontal extender horizontally connected to a side surface of the base for clipping the mobile phone. A flat end of the main pyramidal prism is connected to the turntable.

The vertical extender comprises a driving motor installed inside the base, an outer screw thread drive shaft connected to an output end of the driving motor, an inner slide tube fixedly attached on top of the base, an outer slide sleeve axially and slidably connected at an outside of the inner slide tube, and an inner screw thread elevation tube disposed axially inside the outer slide sleeve. The outer screw thread drive shaft and the inner screw thread elevation tube cooperate with each other, the driving motor is connected to the signal receiver, the driving motor drives the outer screw thread drive shaft to rotate, causing the outer slide sleeve to axially move up or down the inner slide tube.

The horizontal extender comprises a horizontal sleeve fixedly attached to the side surface of the base, a tension spring disposed inside the horizontal sleeve, and a clipping rod connected to the tension spring. The clipping rod comprises a slider slidably attached inside the horizontal sleeve, a connection rod connected to the slider, and a stopper rod vertically connected on top of a surface of the connection rod. The tension spring is connected to said slider.

For guiding purposes, a guide rail is disposed axially at an outer surface of the inner slide tube, a guide strip corresponding to the guide rail is disposed axially at an inner surface of the outer slide sleeve. The outer slide sleeve and the inner slide tube slide axially inside the guide rail through the guide strip.

At least a row of stopper rails is disposed axially at an outer side wall of the inner slide tube, each stopper rail comprises at least two stopper round cavities. A mounting hole corresponding to the stopper round cavity is disposed at an inner side wall at a bottom of the outer slide sleeve. At least one alignment mechanism corresponding to the stopper round cavity is connected to the mounting hole, the alignment mechanism comprises an alignment spring disposed inside the mounting hole and an alignment bead connected to an end of the alignment spring. The outer slide sleeve is fit into the stopper round cavity of the inner sliding tube through the alignment bead.

Two rows of stopper rails are disposed on an outer side surface of the inner slide tube, each stopper rail comprises eight stopper round cavities.

The stopper round cavity has a hemispherical vertical cross section.

Adjacent stopper round cavities has a distance of 0.5-0.8 cm therebetween.

A diameter of the mounting hole is larger than a diameter of said alignment bead.

A rotational motor and a signal receiver connected to the rotational motor is installed inside the horizontal bar for connecting to the turntable. The signal receiver is connected to said mobile phone application program.

A V-shaped stopper bar is connected to the side wall of the base.

The flat end of the main pyramid prism has an area of 1-1.5 times of an area of the display of the mobile phone.

The advantages of the present invention is: with the 3D projector for mobile phone as described, when such 3D projector is used, signal can be received through the inverted-L shaped frame, achieving upwards or downwards movement or rotation of the main pyramidal prism. Projection is achieved through the main pyramidal prism, thereby allowing viewers to watch 3D movies using mobile phones, and can also adjust 3D effects through making simple gestures according to the plot or viewer desire. This meets and satisfies the need for technology and experience of entertainment for the young people today.

### BRIEF DESCRIPTION OF DRAWINGS

The present invention is further explained below with the accompanying drawings and embodiments.

FIG. 1 is an overall structural schematic diagram of a 3D projector for mobile phone according to the present invention.

FIG. 2 is an isometric view of the 3D projector of FIG. 1.

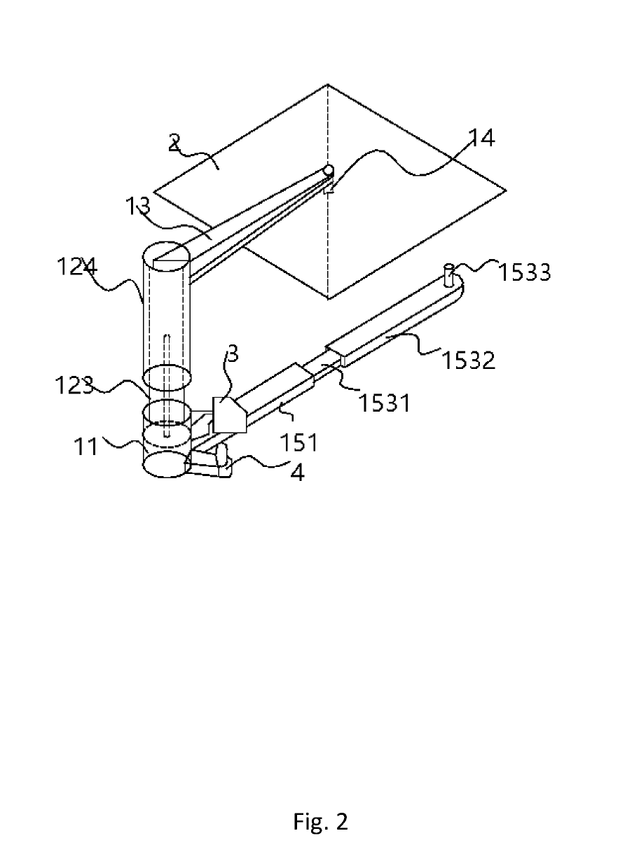

Legends in the drawings: 1 inverted-L shaped frame, 11 base, 12 vertical extender, 121 driving motor, 122 outer screw thread drive shaft, 123 inner slide tube, 1231 guide rail, 1232 stopper round cavity, 124 outer slide sleeve, 1241 guide strip, 1242 mounting hold, 1243 alignment spring, 1244 alignment bead, 125 inner screw thread elevation tube, 13 horizontal tube, 14 turntable, 15 horizontal extender, 151 horizontal sleeve, 152 tension spring, 153 clipping rod, 1531 slider, 1532 connection rod, 1533 stopper rod, 2 main pyramidal prism, 3 auxiliary pyramidal prism, 4 V-shaped stopper rod.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

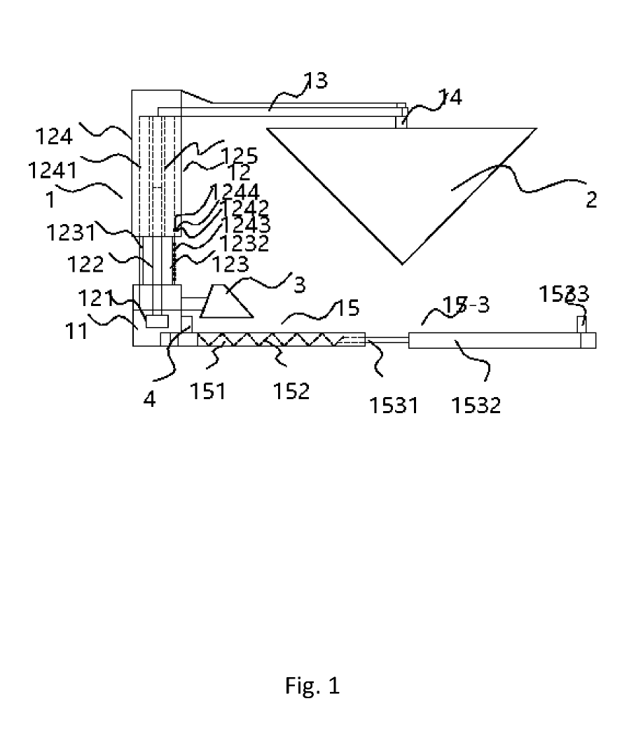

In a 3D projector for mobile phone as shown in FIG. 1, the 3D projector comprises an inverted-L shaped frame 1, a main pyramidal prism 2 located directly on top of a display of the mobile phone, and an auxiliary pyramidal prism 3 located directly on top of a front camera of the mobile phone. The flat surface of the main pyramidal prism 2 has an area of around 1-1.5 times of the area of the display of the mobile phone. A signal receiver is disposed inside the inverted-L shaped frame 1 for receiving a mobile phone application program. The application program can be connected through USB or Bluetooth to control a rotation of turntable 14 and an extension or retraction of vertical extender 12.

The inverted-L shaped frame 1 comprises a base 11. An inner slide tube 123 is connected vertically on top of the base 11. A V-shaped stopper bar 4 is connected to a side surface of the base 11. An outer slide sleeve 124 is axially and slidably connected at an outside of said inner slide tube 123. An inner screw thread elevation tube 125 is disposed inside the outer sliding sleeve 124, and cooperates with an outer screw thread drive shaft 122. A driving motor 121 is installed inside the base 11, the outer screw thread drive shaft 122 is connected at an output end of the driving motor 121. The driving motor 121 is connected to the signal receiver, the driving motor 121 drives the outer screw thread drive shaft 122 to rotate, causing the outer slide sleeve 124 move axially on the inner slide tube 123.

A guide rail 1231 is disposed axially at an outer surface of the inner slide tube 123, a guide strip 1241 corresponding to the guide rail 1231 is disposed axially at an inner side surface of the outer slide sleeve 124. The outer slide sleeve 124 and the inner slide tube 123 slide axially inside the guide rail 1231 through the guide strip 1241. Two rows of stopper rails are disposed at an outside surface of the inner slide tube, each stopper rail having eight stopper round cavities 1232, the stopper round cavity 1232 having a hemispherical vertical cross section. Mounting holes 1242 corresponding to the stopper round cavities 1232 are disposed at an inner surface of a bottom of the outer slide sleeve 124. The mounting hole 1242 has at least one alignment mechanism corresponding to the stopper round cavity 1232, the alignment mechanism includes an alignment spring 1243 disposed inside the mounting hole and an alignment bead 1244 attached to an end of the alignment spring 1243. The outer sliding sleeve 124 is fit into the stopper round cavity 1232 of the inner slide tube 123 through the alignment bead 1244.

A horizontal bar 13 is horizontally connected to a top end of the outer sliding sleeve 124. A turntable 14 is rotationally connected to a bottom surface at an end of the horizontal bar. A rotational motor and a signal receiver connected to the rotational motor is installed inside the horizontal bar 13 for connecting to the turntable 14. The signal receiver connects to the mobile phone application program, and controls the rotational motor to rotate the turntable 14.

A horizontal extender 15 is horizontally connected to a side surface of the base 11 for clipping the mobile phone. The horizontal extender 15 includes a horizontal sleeve 151 fixedly attached to the side surface of the base 11, a tension spring 152 disposed inside the horizontal sleeve 151, and a clipping rod 153 connected to the tension spring 152. The clipping rod 153 includes a slider 1531 slidably connected inside the horizontal sleeve 151, a connection rod 1532, and a stopper rod 1533 vertically connected to a surface of the connection rod 1532. The tension spring 1532 is connected to the slider 1531. The flat end of the main pyramidal prism 2 is connected to the turntable 14.

In the 3D projector for mobile phone as in the present invention, when the mobile phone is placed on the horizontal extender 15, the main pyramidal prism 2 is disposed directly on top of the display of the mobile phone, with the vertex end of the main pyramidal prism 2 facing the display. Video played on the mobile phone can be projected onto the main pyramidal prism 2 for the user to view. The auxiliary pyramidal prism 3 is disposed directly on top of the front camera of the mobile phone. When the user performs gestures in front of the auxiliary pyramidal prism 3 within a viewable angle range, the gesture can be projected onto the front camera through the auxiliary pyramidal prism 3. The mobile phone application program receives and processes the gesture from the front camera, further having gestures such as up, down or rotate gestures to send a signal to the signal receiver in the inverted-L shaped frame 1 to control the vertical extender 12 of the inverted-L shaped frame 1 to extend or retract, or to control the turntable 14 to rotate. For example, if the plot is that a person in the video is running towards the display, the viewer can make a move down gesture, then the main pyramidal prism 2 will move downwards such that the viewer can feel the person running towards the viewer and moving closer towards the viewer. Conversely, when the viewer make a move up gesture, the main pyramidal prism 2 moves upwards, the viewer can more really feel the person in the video running away.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A 3D projector for mobile phone, characterized in that:
comprising an inverted-L shaped frame, a signal receiver disposed inside said inverted-L shaped frame for receiving a mobile phone application program, a main pyramidal prism disposed directly on top of a display of said mobile phone, and an auxiliary pyramid prism disposed directly on top of a front camera of said mobile phone;
said inverted-L shaped frame comprising a base, a vertical extender vertically connected on top of said base, a horizontal bar horizontally connected to a top end of said vertical extender, a turntable rotationally connected to a bottom surface at an end of said horizontal bar, and a horizontal extender horizontally connected to a side surface of said base for clipping said mobile phone, a flat end of said main pyramidal prism being connected to said turntable;
said vertical extender comprising a driving motor installed inside said base, an outer screw thread drive shaft connected to an output end of said driving motor, an inner slide tube fixedly attached on top of said base, an outer slide sleeve axially and slidably connected at an outside of said inner slide tube, and an inner screw thread elevation tube disposed axially inside said outer slide sleeve, said outer screw thread drive shaft and said inner screw thread elevation tube cooperate with each other, said driving motor being connected to said signal receiver, said driving motor drives said outer screw thread drive shaft to rotate, causing said outer slide sleeve to axially move against said inner slide tube.

2. The 3D projector for mobile phone according to claim 1, characterized in that: said horizontal extender comprising a horizontal sleeve fixedly attached to said side surface of said base, a tension spring disposed inside said horizontal sleeve, and a clipping rod connected to said tension spring, said clipping rod comprising a slider slidably attached inside said horizontal sleeve, a connection rod connected to said slider, and a stopper rod vertically connected on top of a surface of said connection rod, said tension spring being connected to said slider.

3. The 3D projector for mobile phone according to claim 1, characterized in that: a guide rail is disposed axially at an outer surface of said inner slide tube, a guide strip corresponding to said guide rail is disposed axially at an inner surface of said outer slide sleeve, said outer slide sleeve and said inner slide tube slide axially inside said guide rail through said guide strip.

4. The 3D projector for mobile phone according to claim 1, characterized in that: at least a row of stopper rails is disposed axially at an outer side wall of said inner slide tube, each stopper rail comprises at least two stopper round cavities, a mounting hole corresponding to said stopper round cavity is disposed at an inner side wall at a bottom of said outer slide sleeve, at least one alignment mechanism corresponding to said stopper round cavity is connected to said mounting hole, said alignment mechanism comprises an alignment spring disposed inside said mounting hole and an alignment bead connected to an end of said alignment spring, said outer slide sleeve is fit inside said stopper round cavity of said inner sliding tube through said alignment bead.

5. The 3D projector for mobile phone according to claim 4, characterized in that: two rows of stopper rails are disposed on an outer side surface of said inner slide tube, each said stopper rail comprises eight stopper round cavities.

6. The 3D projector for mobile phone according to claim 4, characterized in that: adjacent said stopper round cavities has a distance of 0.5-0.8 cm therebetween.

7. The 3D projector for mobile phone according to claim 4, characterized in that: a diameter of said mounting hole is larger than a diameter of said alignment bead.

8. The 3D projector for mobile phone according to claim 1, characterized in that: a rotational motor and a signal receiver connected to said rotational motor is installed inside said horizontal bar for connecting to said turntable, said signal receiver is connected to said mobile phone application program.

9. The 3D projector for mobile phone according to claim 1, characterized in that: a V-shaped stopper bar is connected to said side wall of said base.

10. The 3D projector for mobile phone according to claim 1, characterized in that: said flat end of said main pyramid prism has an area of 1-1.5 times of an area of said display of said mobile phone.
